(19) United States
(12) Patent Application Publication
(10) Pub. No.: US 2016/0364019 A1
(43) Pub. Date: Dec. 15, 2016

(54) HANDHELD OPERATION DEVICE

(71) Applicant: COOLER MASTER TECHNOLOGY INC., New Taipei City (TW)

(72) Inventor: Yu-hsun Cheng, New Taipei City (TW)

(21) Appl. No.: 14/736,274

(22) Filed: Jun. 11, 2015

(51) Int. Cl. G06F 3/0354

(52) U.S. Cl. CPC G06F 3/03543

(57) ABSTRACT

A handheld operation device includes a casing, a circuit board, a socket, an encoder and a roller. The circuit board is disposed in the casing. The socket is disposed on the circuit board. The encoder is detachably disposed in the socket. The roller is rotatably connected to the encoder and exposed out of the casing. Since the encoder is detachably disposed in the socket, a user can detach the encoder from the socket directly without using any tools.

### BACKGROUND OF THE INVENTION

1. Field of the Invention

The invention relates to a handheld operation device and, more particularly, to a handheld operation device allowing a user to replace an encoder conveniently and rapidly.

2. Description of the Prior Art

As technology advanced and developed, computers have been widely used in daily life. A mouse, which is the most common input device, can be found in variety of computers for users to input desired functions. In general, a roller in the mouse has to cooperate with an encoder to perform a roller function. In the prior art, the encoder is fixed on a circuit board by a surface mount technology (SMT). Accordingly, only a welding process can be performed to detach the encoder from the circuit board. In other words, the user cannot detach the encoder from the circuit board without using specific tools. Furthermore, most of the users are not familiar with the welding process. When the encoder fails, the user cannot replace the encoder himself/herself. Therefore, it is very inconvenient and confused for the user.

### SUMMARY OF THE INVENTION

The invention provides a handheld operation device allowing a user to replace an encoder conveniently and rapidly, so as to solve the aforesaid problems.

According to an embodiment of the invention, a handheld operation device comprises a casing, a circuit board, a socket, an encoder and a roller. The circuit board is disposed in the casing. The socket is disposed on the circuit board. The encoder is detachably disposed in the socket. The roller is rotatably connected to the encoder and exposed out of the casing.

Preferably, the socket has a plurality of fixing portions and the circuit board has a plurality of fixing holes corresponding to the fixing portions, wherein the fixing portions are fixed in the fixing holes.

Preferably, the fixing portions have different sizes and the fixing holes corresponding to the fixing portions also have different sizes.

Preferably, the encoder has a plurality of first pins and a plurality of second pins, and the socket has a plurality of first positioning holes corresponding to the first pins and a plurality of second positioning holes corresponding to the second pins, wherein the first pins are disposed in the first positioning holes, and the second pins are disposed in the second positioning holes.

Preferably, the socket further has a plurality of metal resilient members disposed in the first positioning holes, such that the first pins are electrically connected to the metal resilient members.

As mentioned in the above, the invention disposes the socket on the circuit board of the handheld operation device and the encoder is detachably disposed in the socket. When the pins of the encoder are disposed in the positioning holes of the socket, the metal resilient members in the positioning holes will clamp the pins, so as to fix the encoder and form an electrical connection. Since the encoder is detachably disposed in the socket, a user can detach the encoder from the socket directly without using any tools. Accordingly, when the encoder fails, the user can replace the encoder conveniently and rapidly, so as to enhance product value of the handheld operation device of the invention. Furthermore, through the cooperation between the fixing portions of the socket and the fixing holes of the circuit board, the socket can be positioned on the circuit board accurately during assembly. Moreover, when the fixing portions and the fixing holes have different sizes correspondingly, the invention can prevent the socket from being placed in a wrong direction while the socket is being assembled to the circuit board.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating a handheld operation device according to an embodiment of the invention.

FIG. 2 is a schematic view illustrating the inner components of the handheld operation device shown in FIG. 1 from another viewing angle.

FIG. 3 is an exploded view illustrating the inner components of the handheld operation device shown in FIG. 1.

FIG. 4 is an exploded view illustrating the inner components of the handheld operation device shown in FIG. 1 from another viewing angle.

FIG. 5 is a schematic view illustrating the encoder shown in FIG. 4 being disposed in the socket.

FIG. 6 is a cross-sectional view illustrating the inner components of the handheld operation device shown in FIG. 1 along line X-X.

### DETAILED DESCRIPTION

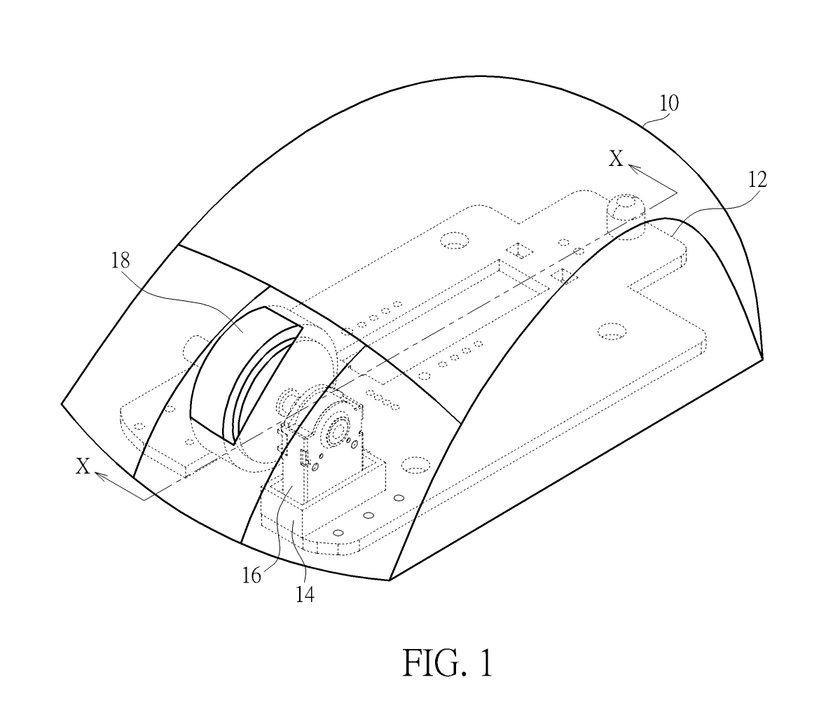

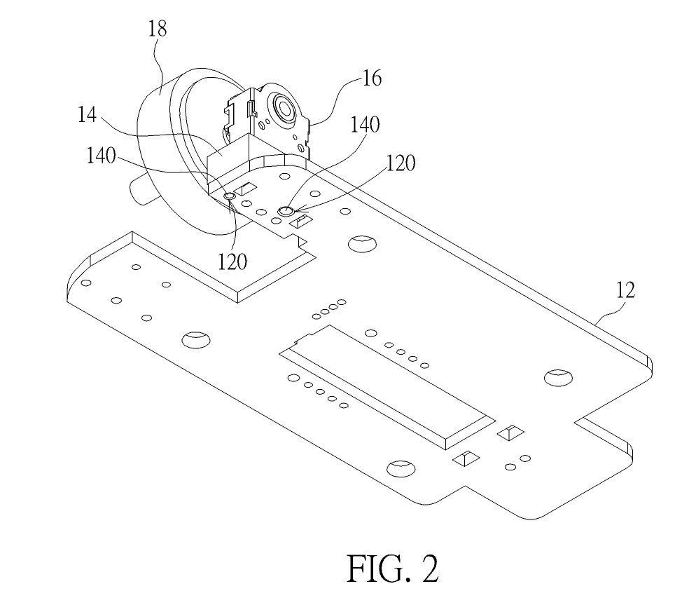

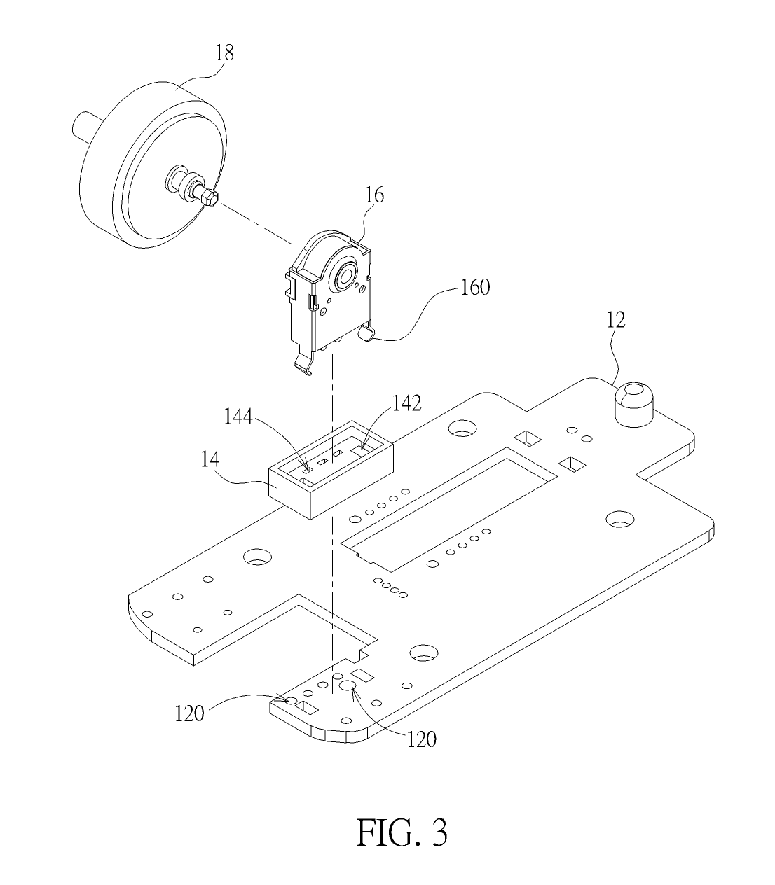

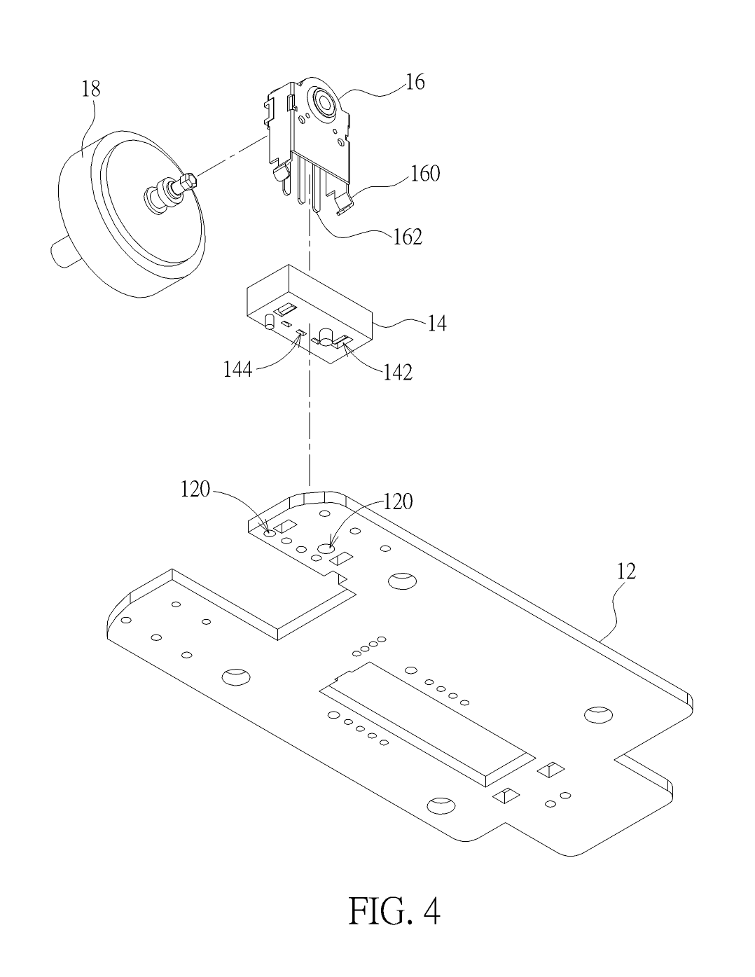

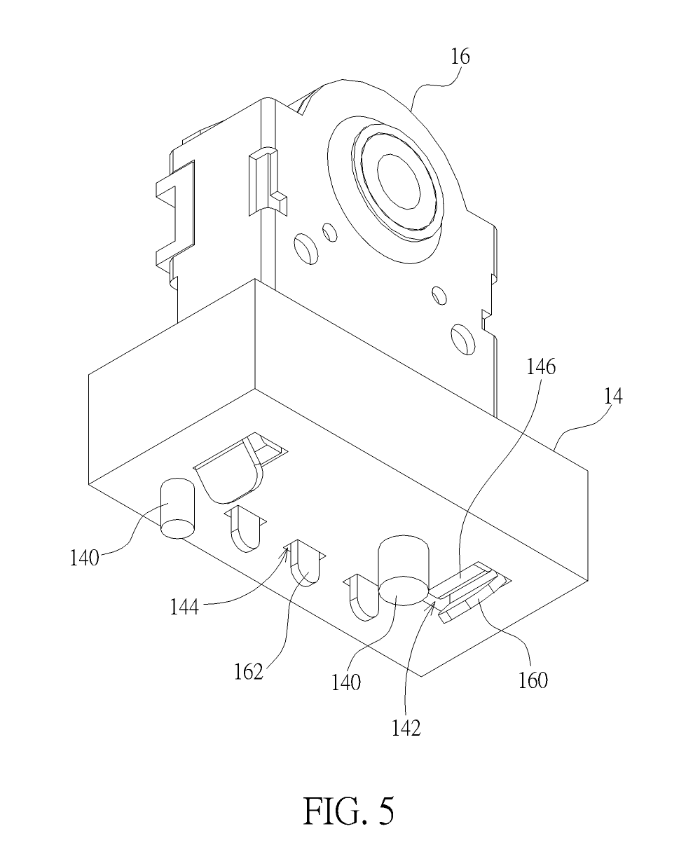

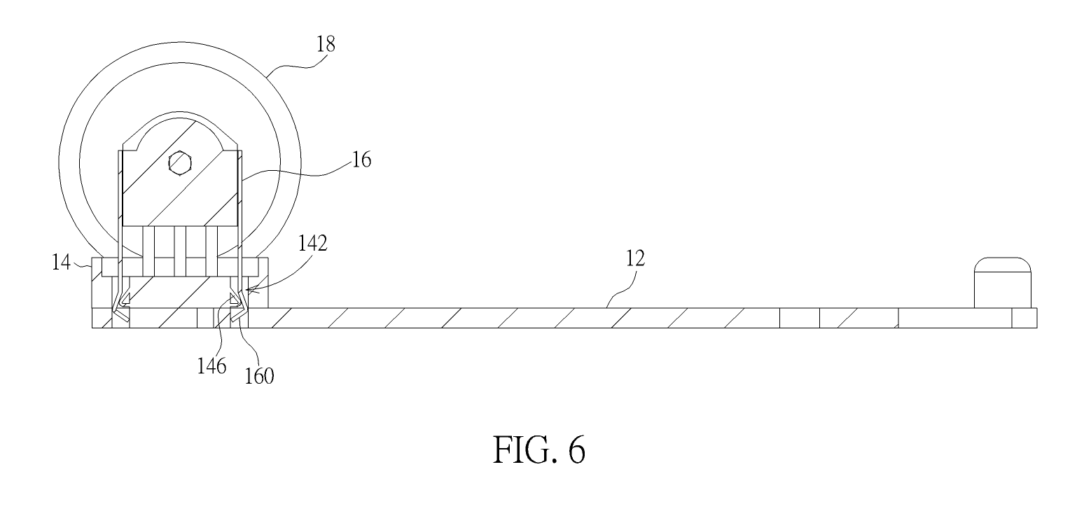

Referring to FIGS. 1 to 6, FIG. 1 is a schematic view illustrating a handheld operation device 1 according to an embodiment of the invention, FIG. 2 is a schematic view illustrating the inner components of the handheld operation device 1 shown in FIG. 1 from another viewing angle, FIG. 3 is an exploded view illustrating the inner components of the handheld operation device 1 shown in FIG. 1, FIG. 4 is an exploded view illustrating the inner components of the handheld operation device 1 shown in FIG. 1 from another viewing angle, FIG. 5 is a schematic view illustrating the encoder 16 shown in FIG. 4 being disposed in the socket 14, and FIG. 6 is a cross-sectional view illustrating the inner components of the handheld operation device 1 shown in FIG. 1 along line X-X.

The handheld operation device 1 of the invention may be a mouse, a joystick or other devices capable of being held by a user to perform operation. A mouse is illustrated in FIG. 1 as an example for depicting the features of the invention, but the handheld operation device 1 of the invention is not limited to the mouse.

As shown in FIGS. 1 to 4, the handheld operation device 1 comprises a casing 10, a circuit board 12, a socket 14, an encoder 16 and a roller 18. The circuit board 12 is disposed in the casing 10, wherein the circuit board 12 may be a printed circuit board or other circuit boards and there is a control chip (not shown) disposed on the circuit board 12. The socket 14 is disposed on the circuit board 12, wherein the socket 14 may be made of, but not limited to, a plastic material with fireproof characteristic. The encoder 16 is detachably disposed in the socket 14, wherein the encoder 16 may be, but not limited to, a mechanical encoder. The roller 18 is rotatably connected to the encoder 16 and exposed out of the casing 10.

In this embodiment, the socket 14 has a plurality of fixing portions 140 and the circuit board 12 has a plurality of fixing holes 120 corresponding to the fixing portions 140. Through the cooperation between the fixing portions 140 of the socket 14 and the fixing holes 120 of the circuit board 12, the socket 14 can be positioned on the circuit board 12 accurately during assembly. When the socket 14 is disposed on the circuit board 12, the fixing portions 140 of the socket 14 may be fixed in the fixing holes 120 of the circuit board 12 through welding, engagement or other fixing manners. Preferably, the fixing portions 140 may have different sizes and the fixing holes 120 corresponding to the fixing portions 140 may also have different sizes, as shown in FIG. 4. When the fixing portions 140 and the fixing holes 120 have different sizes correspondingly, the invention can prevent the socket 14 from being placed in a wrong direction while the socket 14 is being assembled to the circuit board 12.

In this embodiment, the encoder 16 may have a plurality of first pins 160 and a plurality of second pins 162, and the socket 14 may have a plurality of first positioning holes 142 corresponding to the first pins 160 and a plurality of second positioning holes 144 corresponding to the second pins 162. The first pins 160 can be disposed in the first positioning holes 142 and the second pins 162 can be disposed in the second positioning holes 144, such that the encoder 16 can be detachably disposed in the socket 14.

Furthermore, the socket 14 may further have a plurality of metal resilient members 146 disposed in the first positioning holes 142. When the socket 14 is disposed on the circuit board 12, the metal resilient members 146 can be electrically connected to the control chip (not chown) through circuit layout of the circuit board 12. Moreover, when the encoder 16 is disposed in the socket 14, the first pins 160 of the encoder 16 are electrically connected to the metal resilient members 146 of the socket 14. Accordingly, the metal resilient members 146 can transmit signals generated by the encoder 16 in response to the roller 18 to the control chip (not shown) on the circuit board 12, so as to execute corresponding roller function.

In this embodiment, the first pins 160 of the encoder 16 may be cantilever structure. When the first pins 160 of the encoder 16 are inserted into the first positioning holes 142 of the socket 14, the first pins 160 will be pressed by an inner wall of the first positioning holes 142 to generate slight elastic deformation, such that the first pins 160 will contact the metal resilient members 146 in the first positioning holes 142 and form an electrical connection. At this time, the first pins 160 are clamped between the inner wall of the first positioning holes 142 and the metal resilient members 146, such that the encoder 16 is fixed in the socket 14.

When the user wants to replace the encoder 16, the user only has to pull the encoder 16 upward with respect to the socket 14, such that the encoder 16 can be detached from the socket 14 easily. On the other hand, the user only has to insert the first pins 160 and the second pins 162 of the encoder 16 into the first positioning holes 142 and the second positioning holes 144 of the socket 14 correspondingly, such that the encoder 16 can be disposed in the socket 14 easily.

As mentioned in the above, the invention disposes the socket on the circuit board of the handheld operation device and the encoder is detachably disposed in the socket. When the pins of the encoder are disposed in the positioning holes of the socket, the metal resilient members in the positioning holes will clamp the pins, so as to fix the encoder and form an electrical connection. Since the encoder is detachably disposed in the socket, a user can detach the encoder from the socket directly without using any tools. Accordingly, when the encoder fails, the user can replace the encoder conveniently and rapidly, so as to enhance product value of the handheld operation device of the invention. Furthermore, through the cooperation between the fixing portions of the socket and the fixing holes of the circuit board, the socket can be positioned on the circuit board accurately during assembly. Moreover, when the fixing portions and the fixing holes have different sizes correspondingly, the invention can prevent the socket from being placed in a wrong direction while the socket is being assembled to the circuit board.

Those skilled in the art will readily observe that numerous modifications and alterations of the device and method may be made while retaining the teachings of the invention. Accordingly, the above disclosure should be construed as limited only by the metes and bounds of the appended claims.

1. A handheld operation device comprising:
a casing;
a circuit board disposed in the casing;
a socket disposed on the circuit board;
an encoder detachably disposed in the socket; and
a roller rotatably connected to the encoder and exposed out of the casing.

2. The handheld operation device of claim 1, wherein the socket has a plurality of fixing portions, the circuit board has a plurality of fixing holes corresponding to the fixing portions, and the fixing portions are fixed in the fixing holes.

3. The handheld operation device of claim 2, wherein the fixing portions have different sizes and the fixing holes corresponding to the fixing portions also have different sizes.

4. The handheld operation device of claim 1, wherein the encoder has a plurality of first pins and a plurality of second pins, the socket has a plurality of first positioning holes corresponding to the first pins and a plurality of second positioning holes corresponding to the second pins, the first pins are disposed in the first positioning holes, and the second pins are disposed in the second positioning holes.

5. The handheld operation device of claim 4, wherein the socket further has a plurality of metal resilient members disposed in the first positioning holes, such that the first pins are electrically connected to the metal resilient members.
